(19) United States
(12) Patent Application Publication
(10) Pub. No.: US 2013/0318965 A1
(43) Pub. Date: Dec. 5, 2013

(54) Supercharged Combined Cycle System With Air Flow Bypass To HRSG And Hydraulically Coupled Fan

(71) Applicant: GENERAL ELECTRIC COMPANY, Schenectady, NY (US)

(72) Inventors: Sanji Ekanayake, Mableton, GA (US); Gordon Raymond Smith, Ballston Spa, NY (US); Alston Ilford Scipio, Mableton, GA (US); Timothy Tah-teh Yang, Greenville, SC (US); Julio Enrique Mestroni, Marietta, GA (US); Kurt Waldner, Marietta, GA (US); Tedd Sellers, Williamsburg, VA (US)

(73) Assignee: GENERAL ELECTRIC COMPANY, Schenectady, NY (US)

(21) Appl. No.: 13/721,946

(22) Filed: Dec. 20, 2012

Related U.S. Application Data
(63) Continuation-in-part of application No. 13/485,160, filed on May 31, 2012.

(51) Int. Cl. F02B 47/08

(52) U.S. Cl. CPC F02B 47/08
USPC 60/605.1; 60/273

(57) ABSTRACT

A supercharging system for a gas turbine system having a compressor, a combustor, a turbine and a shaft includes a prime mover and a fan assembly that provides an air stream at an air stream flow rate. A hydraulic coupler is coupled to the prime mover and the fan assembly and a second torque converter may couple the supercharger prime mover to an electrical generator. The supercharging system also includes a subsystem for conveying a first portion of the air stream to the compressor, and a bypass subsystem for optionally conveying a second portion of the air stream to other uses.

### CROSS-REFERENCE TO RELATED APPLICATIONS

This application is a continuation in part of application Ser. No. 13/485,160, titled SUPERCHARGED COMBINED CYCLE SYSTEM WITH AIR FLOW BYPASS assigned to General Electric Company, the assignee of the present invention. This application is related to application Ser. No. 13/485,273, titled GAS TURBINE COMPRESSOR INLET PRESSURIZATION HAVING A TORQUE CONVERTER SYSTEM, and application Ser. No. ______, titled _______, filed concurrently herewith and both of which are assigned to General Electric Company, the assignee of the present invention.

### TECHNICAL FIELD

The subject matter disclosed herein relates generally to gas turbine systems and more specifically to a gas turbine system with compressor inlet pressurization and a flow control system.

### BACKGROUND

Utility power producers use combined cycle systems because of their inherent high efficiencies and installed cost advantage. Combined cycle power systems and cogeneration facilities utilize gas turbines to generate power. These gas turbines typically generate high temperature exhaust gases that are conveyed into a heat recovery steam generator (HRSG) that produces steam. The steam may be used to drive a steam turbine to generate more power and/or to provide steam for use in other processes. The combination of a gas turbine and a steam turbine achieves greater efficiency than would be possible independently. The output of a combined cycle system is affected by the altitude and variations in the ambient temperature.

Operating power systems at maximum efficiency is a high priority for any generation facility. Factors including load conditions, equipment degradation, and ambient conditions may cause the generation unit to operate under less than optimal conditions. Various methods are available for improving the performance of combined-cycle power plants. Improvements can be made in plant output or efficiency beyond those achievable through higher steam temperatures; multiple steam-pressure levels or reheat cycles. For example, it has become commonplace to install gas fuel heating on new combined-cycle power plants to improve plant efficiency. Additionally, gas turbine inlet air cooling is sometimes considered for increasing gas turbine and combined-cycle output. Another approach is supercharging (compressor inlet pressurization). Supercharging of a gas turbine entails the addition of a fan to boost the pressure of the air entering the inlet of the compressor. In some cases, supercharged turbine systems may include a variable speed supercharging fan located at the gas turbine inlet that is driven by steam energy derived from converting exhaust waste heat into steam. In other cases supercharging the additional stage of compression is not driven by the main gas turbine shaft, but rather by an electric motor. A problem that arises with the use of an electric motor is that in some cases, the parasitic power of the fan motor is more than the additional output of the gas turbine, so the net result is a capacity loss.

### BRIEF DESCRIPTION OF THE INVENTION

In accordance with one exemplary non-limiting embodiment, the invention relates to a supercharging system for a gas turbine system having a compressor, a combustor, a turbine and a shaft. The supercharging system includes a prime mover and a fan assembly that provides an air stream at an air stream flow rate. A hydraulic coupler is coupled to the prime mover and the fan assembly. The supercharging system also includes a subsystem for conveying a first portion of the air stream to the compressor and a bypass subsystem for optionally conveying a second portion of the air stream to other uses.

In another embodiment, a gas turbine system having a compressor, a combustor and a turbine is provided. The gas turbine system also includes a prime mover and a hydraulic coupler coupled to the prime mover. A fan that generates an air stream is coupled to the hydraulic coupler, and a bypass subsystem allocates the air stream between the compressor and other uses.

In another embodiment, a method of operating a combined cycle system includes driving a fan assembly with a prime mover attached to a hydraulic coupler. The method includes determining a first flow rate to be provided to a compressor in the gas turbine, determining a second flow rate to be provided to other uses, and providing the first flow rate to the compressor, and the second flow rate to the other uses.

In another embodiment, a torque converter and an electrical generator at the opposite end of the drive shaft of the supercharger prime mover is included such that the supercharger prime mover can drive the supercharger, the generator or both simultaneously, expanding the combined-plant operational flexibility.

Other features and advantages of the present invention will be apparent from the following more detailed description of the preferred embodiment, taken in conjunction with the accompanying drawings which illustrate, by way of example, the principles of certain aspects of the invention.

### BRIEF DESCRIPTION OF THE DRAWINGS

FIG. 1 is a schematic illustration of an embodiment of a supercharged combined cycle system with air bypass.

FIG. 2 is a schematic illustration of another embodiment of a supercharged combined cycle system with air bypass.

FIG. 3 is a flow chart of an embodiment of a method implemented by a supercharged combined cycle system with air bypass.

FIG. 4 is a chart illustrating a result accomplished by a supercharged combined cycle system with air bypass.

FIG. 5 is a flow chart of an embodiment of a method implemented by a supercharged combined cycle system with air bypass.

FIG. 6 is a chart illustrating a result accomplished by a supercharged combined cycle system with air bypass.

FIG. 7 is a chart illustrating a result accomplished by a supercharged combined cycle system with air bypass.

FIG. 8 is a schematic illustration of an embodiment of a supercharged combined cycle system with air bypass and a hydraulically coupled fan.

FIG. 9 is a schematic illustration of a control system according to an embodiment.

FIG. 10 is a cross-section of a hydraulic coupler.

FIG. 11 is a schematic illustration of a prime mover according to an embodiment.

FIG. 12 is a schematic illustration of a prime mover according to an embodiment.

FIG. 13 is a schematic illustration of a prime mover according to an embodiment.

FIG. 14 is a schematic illustration of a prime mover according to an embodiment.

FIG. 15 is a schematic illustration of a prime mover according to an embodiment.

FIG. 16 is a schematic illustration of a prime mover according to an embodiment.

FIG. 17 is a schematic illustration of a prime mover coupled to an electric generator and a forced draft fan according to an embodiment.

FIG. 18 is a table showing the relative advantages of prime movers.

FIG. 19 is flow chart of an exemplary method of operating a supercharged system.

FIG. 20 is flow chart of an exemplary method of operating a supercharged system.

FIG. 11 is a flow chart of an exemplary method of decoupling a fan from a gas turbine system.

### DETAILED DESCRIPTION OF THE INVENTION

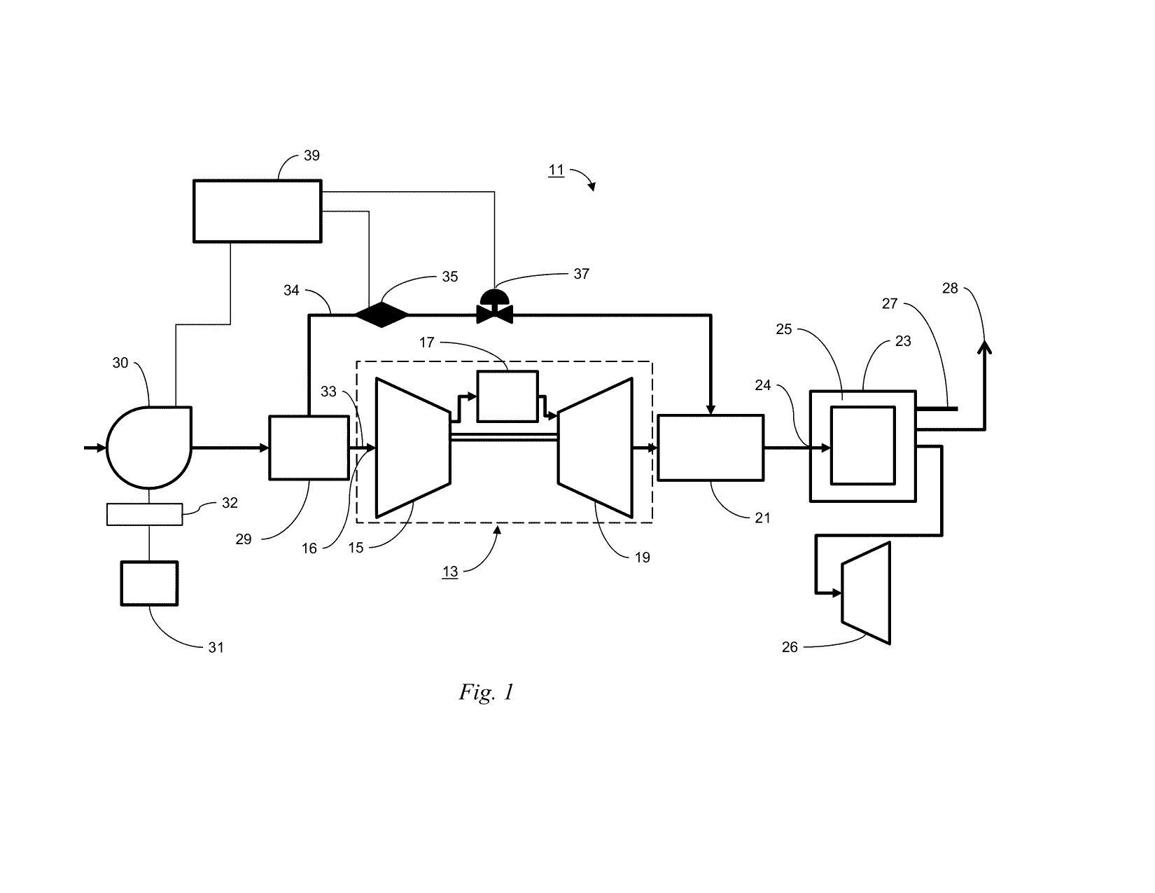

Illustrated in FIG. 1 is a schematic illustration of a supercharged combined cycle system with air bypass (SCCAB system 11) in accordance with one embodiment of the present invention. The SCCAB system 11 includes a gas turbine subsystem 13 that in turn includes a compressor 15, having a compressor inlet 16, a combustor 17 and a turbine 19. An exhaust duct 21 may be coupled to the turbine 19 and a heat recovery steam generator subsystem (HRSG 23). The HRSG 23 recovers heat from exhaust gases from the turbine 19 that are conveyed through HRSG inlet 24 to generate steam. The HRSG 23 may also include a secondary burner 25 to provide additional energy to the HRSG 23. Some of the steam and exhaust from the HRSG 23 may be vented to stack 27 or used to drive a steam turbine 26 and provide additional power. Some of the steam from the HRSG 23 may be transported through process steam outlet header 28 to be used for other processes. The SCCAB system 11 may also include an inlet house and cooling system 29. The inlet house and cooling system 29 is used to cool and filter the air entering the compressor inlet 16 to increase power and avoid damage to the compressor 15.

The SCCAB system 11 also includes a forced draft fan 30 used to create a positive pressure forcing air into the compressor 15. Forced draft fan 30 may have a fixed or variable blade fan (not shown) and a prime mover 31 to drive the blades. Prime mover 31 may be coupled to the forced draft fan 30 through a hydraulic coupler 32. The forced draft fan 30 provides a controllable air stream source though a duct assembly 33 and may be used to increase the mass flow rate of air into the compressor 15. The quantity of air going into the compressor is controlled by the prime mover 31. The compressor inlet 16 may be configured to accommodate slight positive pressure as compared to the slight negative pressure conventional design.

The SCCAB system 11 may also include a bypass 34 (which may include external ducting) that diverts a portion of the air flow from forced draft fan 30 into the exhaust duct 21. This increased air flow provides additional oxygen to the secondary burner 25 to avoid flame out or less than optimal combustion. Bypass 34 may be provided with a flow sensor 35 and a damper valve 37 to control the airflow through the bypass 34. A control system 39 may be provided to receive data from flow sensor 35 and to control the damper valve 37 and the prime mover 31. Control system 39 may be integrated into the larger control system used for operation control of SCCAB system 11. The airflow from the bypass is conveyed to the exhaust duct 21 where the temperature of the combined air and exhaust entering the HRSG 23 may be modulated.

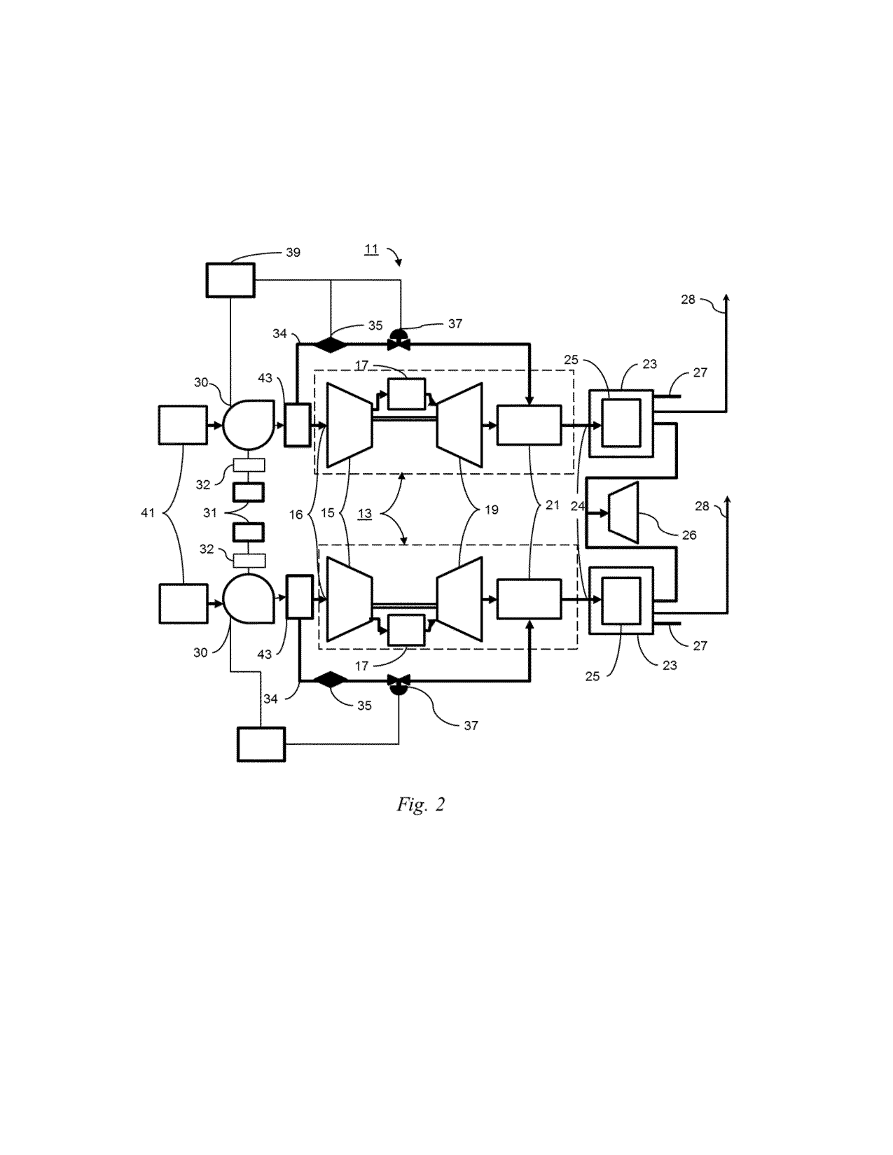

Illustrated in FIG. 2 is another embodiment of a SCCAB system 11 that includes a pair of gas turbine subsystem(s) 13. In this embodiment, the exhaust of the pair of gas turbine subsystem(s) 13 is used to drive a steam turbine 26. In this embodiment, an inlet house 41 is positioned upstream of the forced draft fan 30, and a cooling system 43, where the airflow from the fan may be cooled, is positioned downstream of the forced draft fan 30. The bypass 34 is coupled to the cooling system 43. One of ordinary skill in the art will recognize that although in this embodiment two gas turbine subsystem(s) 13 are described, any number of gas turbine subsystem(s) 13 in combination with any number of steam turbine(s) 27 may be used.

In operation, the SCCAB system 11 provides increased air flow into the HRSG 23 resulting in a number of benefits. The SCCAB system 11 may provide an operator with the ability to optimize combined cycle plant flexibility, efficiency and lifecycle economics. For example, boosting the inlet pressure of the gas turbine subsystem 13 improves output and heat rate performance. The output performance of the SCCAB system 11 may be maintained flat (zero degradation) throughout the life cycle of SCCAB system 11 by increasing the level of supercharging (and parasitic load to drive the forced draft fan 30) over time commensurate with the degradation of SCCAB system 11. The use of the prime mover 31 to power the forced draft fan 30 enables and substantially improves system efficiencies under partial-supercharge conditions. Another benefit that may be derived from the SCCAB system 11 is the expansion of the power generation to steam production ratio envelope. This may be accomplished by modulating the exhaust gas temperature at HRSG inlet 24 with air from the forced draft fan 30. Another benefit that may be derived from the SCCAB system 11 is an improved start up rate as a result of the reduction in the purge cycle (removal of built up gas). The SCCAB system 11 may also provide an improved load ramp rate resulting from the modulation of the exhaust temperature at the exhaust duct 21 with air from the forced draft fan 30 provided through the bypass 34. The forced draft fan 30 of the SCCAB system 11 also provides an effective means to force-cool the gas turbine subsystem 13 and HRSG 23, reducing maintenance outage time and improves system availability. The forced draft fan 30 provides comparable benefit for simple cycle and combined-cycle configurations for all gas turbine subsystem(s) 13 delivering in the range of 20% output improvement under hot ambient conditions with modest capital cost.

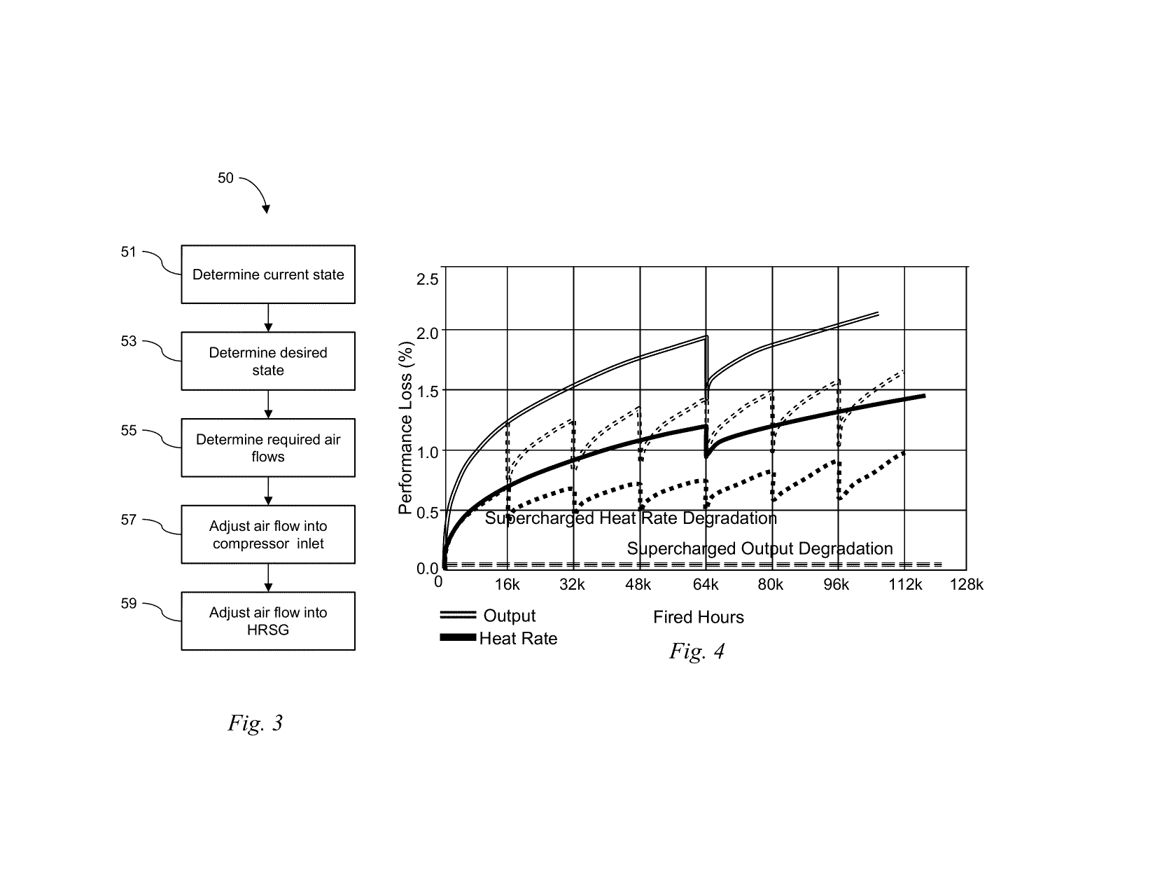

The SCCAB system 11 may implement a method of maintaining the output of a combined cycle plant over time (method 50) as illustrated with reference to FIGS. 3. In step 51 the method 50 may determine the current state, and in step 53 the method 50 may determine a desired state. The desired state may be to maintain a nominal output over time to compensate for performance losses. Performance losses typically arise as a result of wear of components in the gas turbine over time. These losses may be measured or calculated. In step 55 the method 50 may determine the required increased air mass flow to maintain the desired output. Based on that determination, in step 57, the method 50 may adjust the air mass flow into the compressor inlet 16. In step 59, the method 50 may adjust the combined air and exhaust mass flow into the HRSG inlet 24.

FIG. 4 illustrates the loss of output and heat rate over time (expressed in percentages) of a conventional combined cycle system and a SCCAB system 11. Gas turbines suffer a loss in output over time, as a result of wear of components in the gas turbine. This loss is due in part to increased turbine and compressor clearances and changes in surface finish and airfoil contour. Typically maintenance or compressor cleaning cannot recover this loss, rather the solution is the replacement of affected parts at recommended inspection intervals. However, by increasing the level of supercharging using forced draft fan 30 output performance may be maintained, although at a cost due to the parasitic load to drive the forced draft fan 30. The top curve (unbroken double line) illustrates the typical output loss of a conventional combined cycle system. The second curve (broken double lines) illustrates the expected output loss with periodic inspections and routine maintenance. The lower curve (broken triple line) shows that the output loss of an SCCAB system 11 may be maintained at near 0%. Similarly, the heat rate degradation of a conventional combined cycle system (single solid curve) may be significantly improved with an SCCAB system 11.

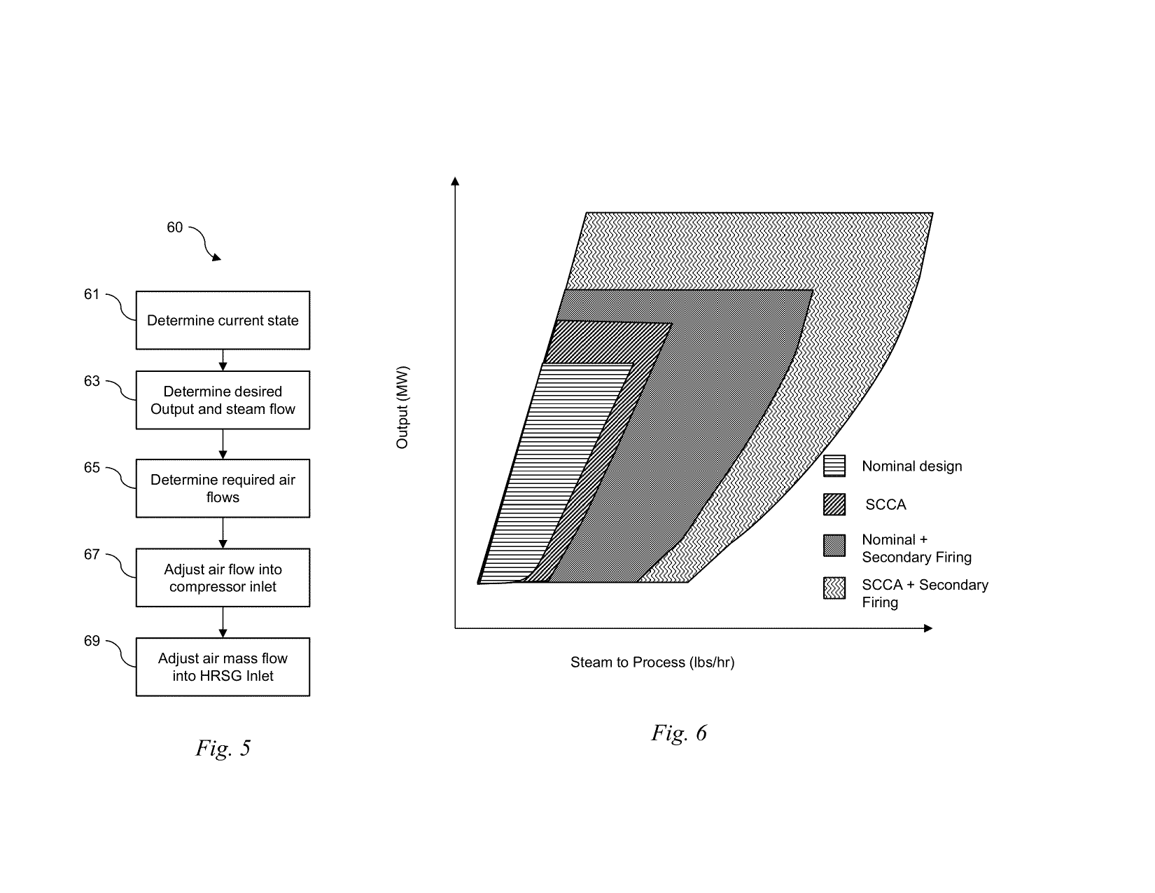

FIG. 5 illustrates a method of controlling the steam output of a SCCAB system 11 (method 60). In step 61, method 60 may initially determine the current state. In step 63, the method 60 may also determine the desired output and steam flow. In step 65, the method 60 may determine the required increased air flow to the compressor inlet 16 and the HRSG inlet 24. In step 67, method 60 may then adjust the air flow into the compressor inlet 16 and the combined exhaust and air flow into the HRSG inlet 24 (method element 69), to provide the desired steam output.

FIG. 6 illustrates expanded operating envelope to maintain constant steam flow. The vertical axis measures output in MW and horizontal axes measures steam mass flow. The interior area (light vertical cross hatch) shows the envelope of a conventional combined cycle system. The envelope of an SCCAB system 11 is shown in diagonal cross hatching, and a larger area illustrates the performance of an SCCAB system 11 combined with secondary firing in the HRSG 23.

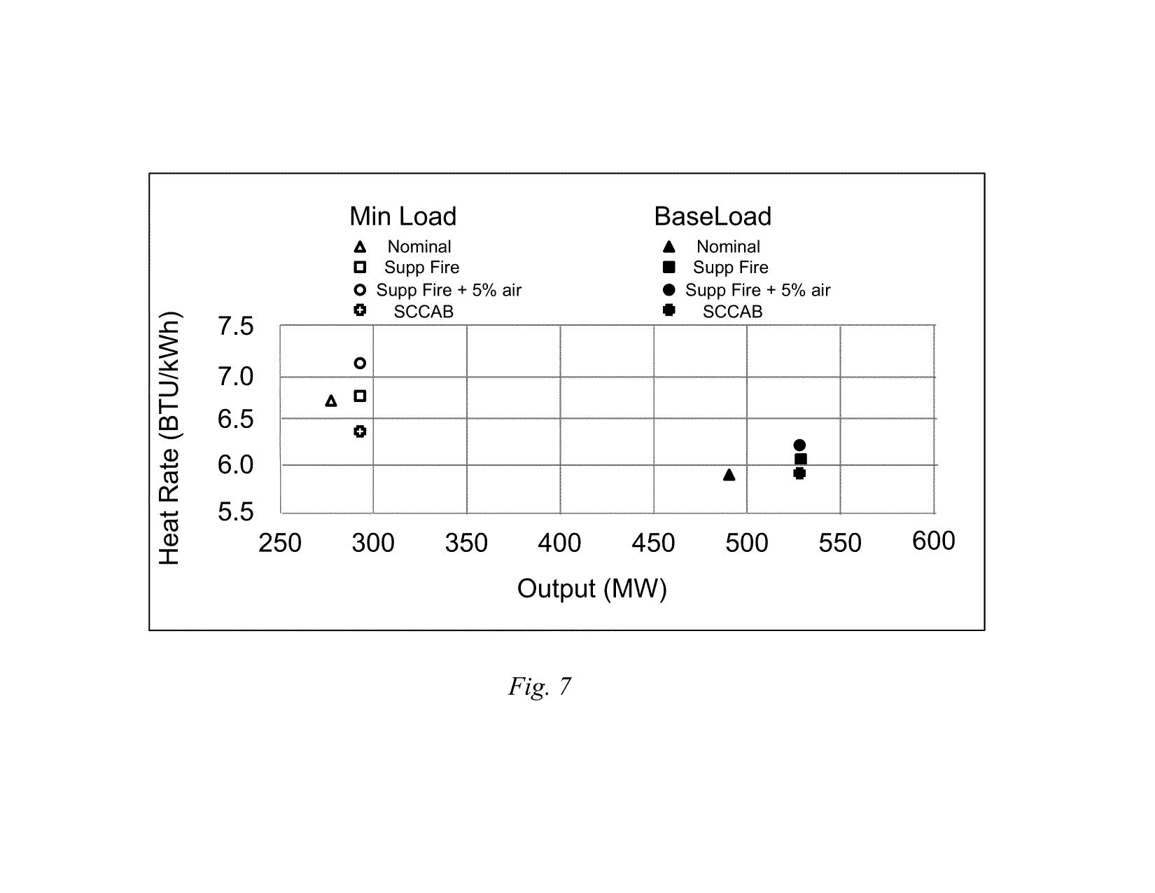

FIG. 7 is a chart that illustrates the improved operational performance of an SCCAB system 11 at a specific ambient temperature in comparison with conventional combined cycle systems at minimum and base loads. The horizontal axis measures output in MW and the vertical axis measures heat rate (the thermal energy (BTU's) from fuel required to produce one kWh of electricity). The chart illustrates the improved efficiency delivered by the SCCAB system 11.

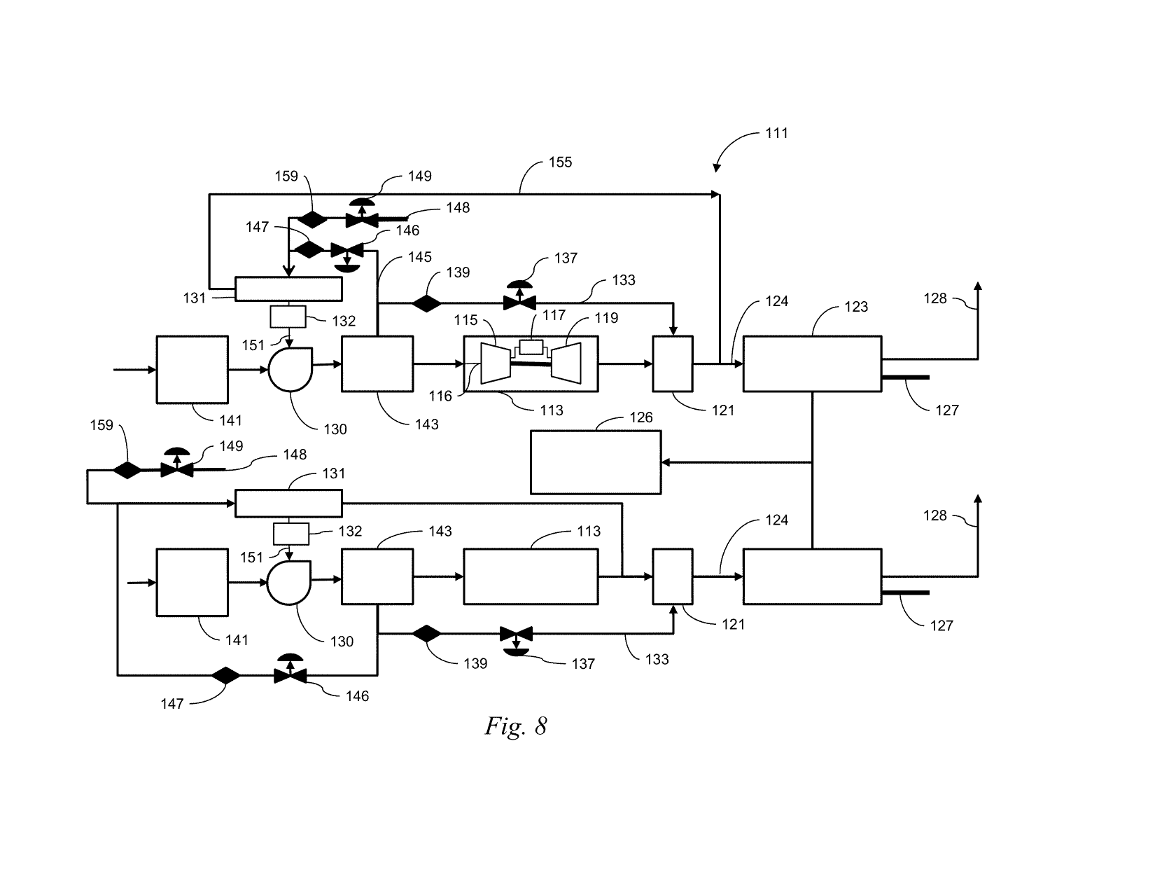

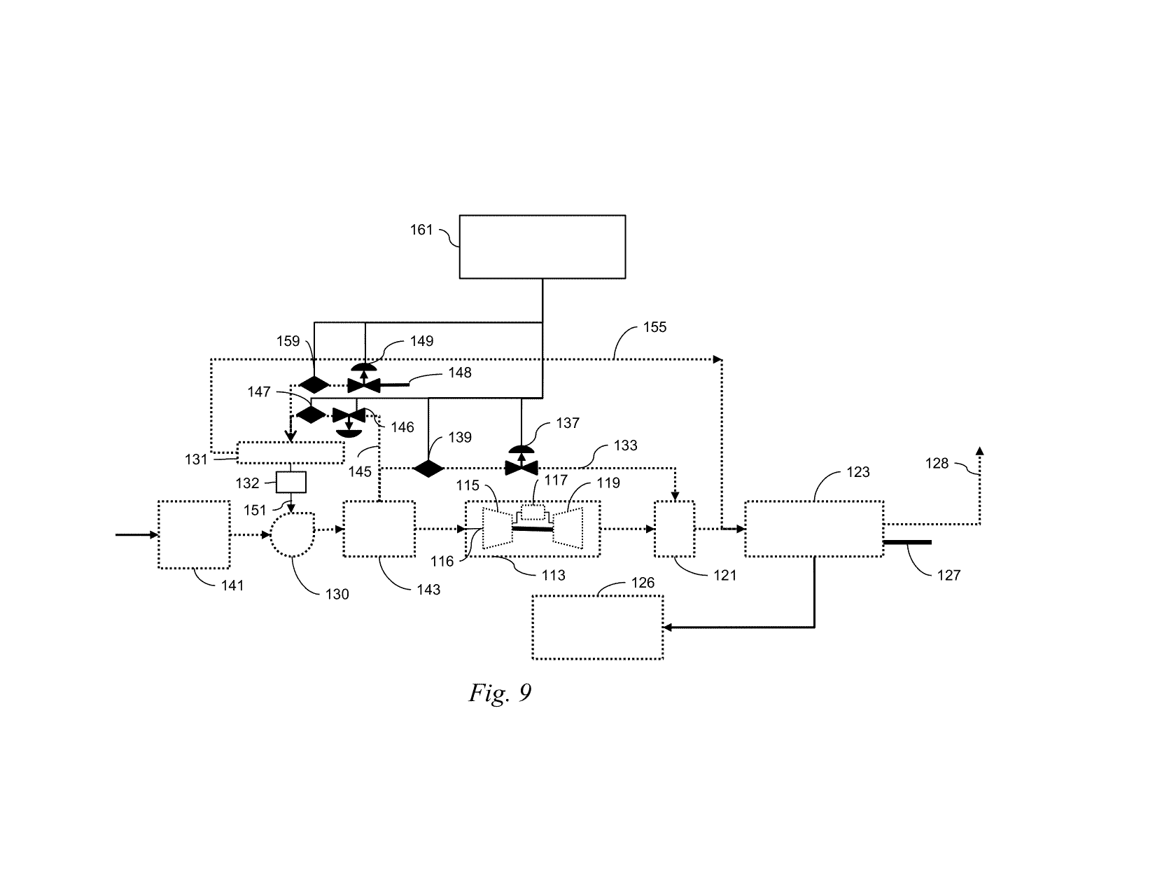

FIG. 8 is a schematic illustration of a combined cycle system 111 in accordance with another embodiment of the present invention. The combined cycle system 111 includes a gas turbine subsystem 113 that in turn includes a compressor 115, having a compressor inlet 116, a combustor 117 and a turbine 119. An exhaust duct 121 may be coupled to the gas turbine subsystem 113 and a heat recovery steam generator subsystem (HRSG 123). The HRSG 123 recovers heat from exhaust gases from the gas turbine subsystem 113 that are conveyed through HRSG inlet 124 to generate steam. Some of the steam and exhaust from the HRSG 123 may be used to drive a steam turbine 126 and provide additional power or vented to stack 127. Some of the steam from the HRSG 123 may be transported through process steam outlet header 128 to be used for other processes.

The combined cycle system 111 also includes a forced draft fan 130 used to create a positive pressure forcing air into the compressor 115. Forced draft fan 130 may be a fixed or variable blade fan. Forced draft fan 130 may be driven by a prime mover 131. The prime mover 131 is coupled to the forced draft fan 130 through a hydraulic coupler 132 (e.g. a torque converter). The forced draft fan 130 provides a controllable air stream source and may be used to increase the mass flow rate of air into the gas turbine subsystem 113. The quantity of air going into the gas turbine subsystem 113 is controlled by the prime mover 131 and the hydraulic coupler 132.

The combined cycle system 111 may also include a bypass 133 (which may include external ducting) that diverts a portion of the air flow from forced draft fan 130 into the exhaust duct 121. Bypass 133 may be provided with a flow sensor 139 and a bypass damper valve 137 to control the airflow through the bypass 133. The airflow from the bypass is conveyed to the exhaust duct 121 where the temperature of the combined air and exhaust entering the HRSG 123 may be modulated.

The combined cycle system 111 may also include an inlet house 141 and cooling system 143. The inlet house 141 and cooling system 143 cool and filter the air entering the gas turbine subsystem 113 to increase power and avoid damage to the compressor. In some embodiments the inlet house 141 and the cooling system 143 may be combined and disposed downstream from the forced draft fan 130.

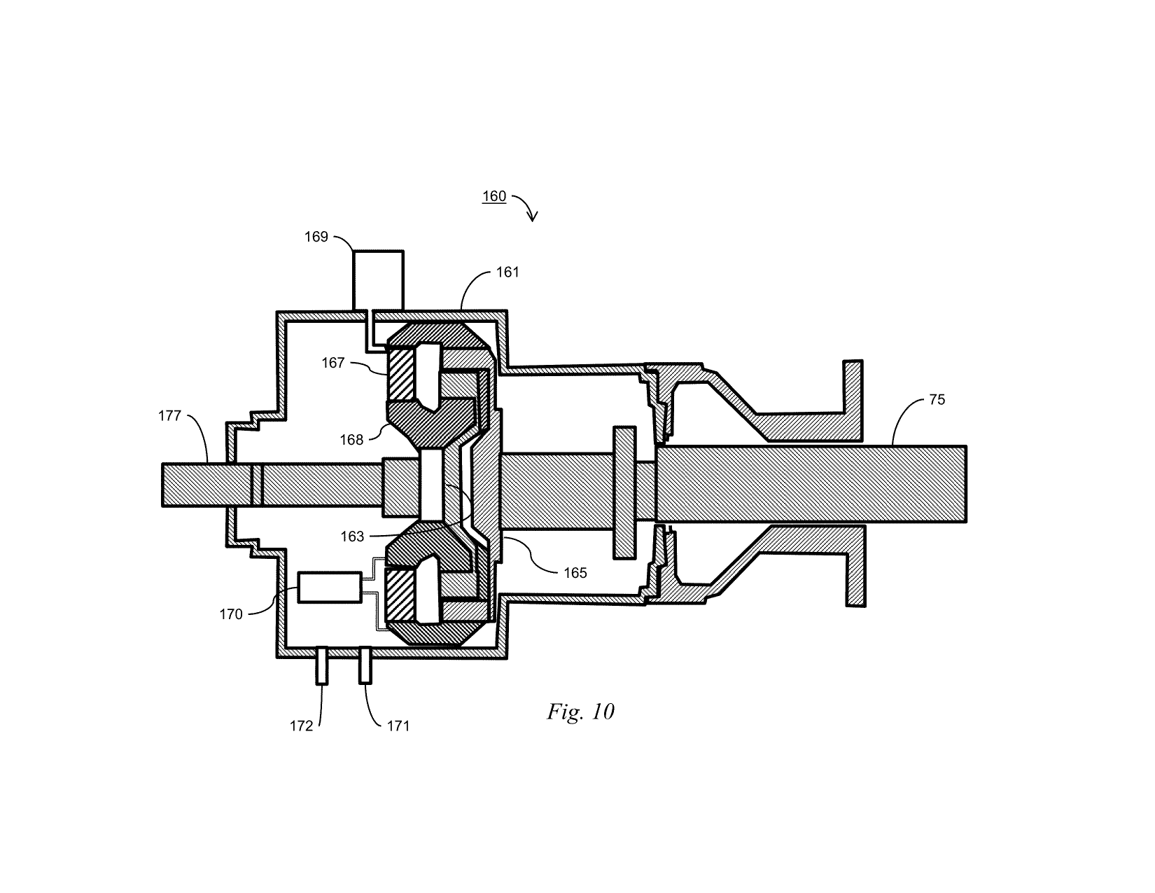

FIG. 10 illustrates an embedment of a hydraulic coupler 132 in the form of a torque converter 160 that provides hydrodynamic fluid coupling. Torque converter 160 includes a housing 161, a pump wheel 163, a turbine wheel 165 and adjustable guide vanes 167. The pump wheel 163, the turbine wheel 165 and the adjustable guide vanes 167 interact within a fluid cavity through which the working fluid flows. The torque converter 160 may also include at least one guide vane actuator 169 that position the adjustable guide vanes 167. The torque converter 160 may also include a working fluid pump 170 coupled to a working fluid supply 171 and working fluid returns 172. The prime mover 131 may be connected to an input shaft 175 that may in turn be connected to the pump wheel 163. An output shaft 177 may be connected to the turbine wheel 165 and may be coupled to the forced draft fan 130.

In operation, the mechanical energy of the prime mover 131 is converted into hydraulic energy through the pump wheel 163. The turbine wheel 165, converts hydraulic energy back into mechanical energy that is transmitted to the output shaft 177. The adjustable guide vanes 167 regulate the mass flow in the circuit. When the adjustable guide vanes 167 are closed (small mass flow) the power transmission is at its minimum. With the adjustable guide vanes completely open (large mass flow), the power transmission is at its maximum. Because of the change in mass flow (due to the adjustable guide vanes 167) the speed of the turbine wheel 165 may be adjusted to match the various operating points of forced draft fan 130. By varying the volume of the working fluid the degree of coupling from the input shaft 175 to the output shaft 177 may be varied. This provides the ability to vary the rotational speed of the forced draft fan 130. The forced draft fan 130 may be decoupled from the output shaft 177 by emptying the working fluid the torque converter 160.

Driving the forced draft fan 130 with a prime mover 131 connected to a hydraulic coupler 132, in place of a direct drive configuration, allows the forced draft fan 130 to operate at variable speeds thereby providing for the control of the flow rate of the airstream provided by the forced draft fan 130. The forced draft fan 130 in combination with the hydraulic coupler 132 improves the part-load efficiency and overall flexibility and reliability of the system. The hydraulic coupler 132 improves the system part load efficiency by minimizing the need to throttle flow on a fixed speed supercharger fan. The hydraulic coupler 132 improves the system overall reliability by providing the means to quickly de-couple the forced draft fan 130 from the input shaft 175 in case of a failure of the forced draft fan 130 or other components of the supercharger and bypass 134.

The SCCAB system 11 provides a number of advantages. Technically, the supercharging system shifts and increases the base load capacity of the gas turbine. The supercharger and bypass 34 combined with the hydraulic coupler 32 allows the forced draft fan 30 to run at variable speeds. The SCCAB system 11 does not have electrical losses associated with motor driven equipment.

In one embodiment, illustrated in FIG. 11 the prime mover 131 may be a gas turbine 201. Gas turbine 201 provides certain benefits over another type of prime mover 131. These benefit include greater reliability, particularly in applications where sustained high power output is required and high efficiencies at high loads. The drawbacks to the use of a gas turbine 201 as a prime mover 131 include lower efficiency than reciprocating engines at part loads and higher costs. The forced draft fan 130 is driven by gas turbine 201 connected to a hydraulic coupler. This configuration eliminates output degradation over time by trading efficiency to make up for output degradation. The forced draft fan 130 driven by gas turbine 201 connected to a hydraulic coupler 132 also provides the operator with the ability to expand the power generation to steam production ratio envelope. Furthermore, the forced draft fan 130 driven by gas turbine 201, increases net power production and improves efficiency of gas turbine 201 subsystem 113 combined cycle system 111. By expanding the operating envelope, the operator may reduce the negative capital & operating cost impact of needing to add a unit at a multi-unit power block where there is a partial output shortfall. The use of a gas turbine 201 as a prime mover 131 has the disadvantages of high capital and maintenance costs. A gas turbine 201 provides a subsystem of medium complexity with high cycle efficiency and very high peak output at fixed supercharger boost.

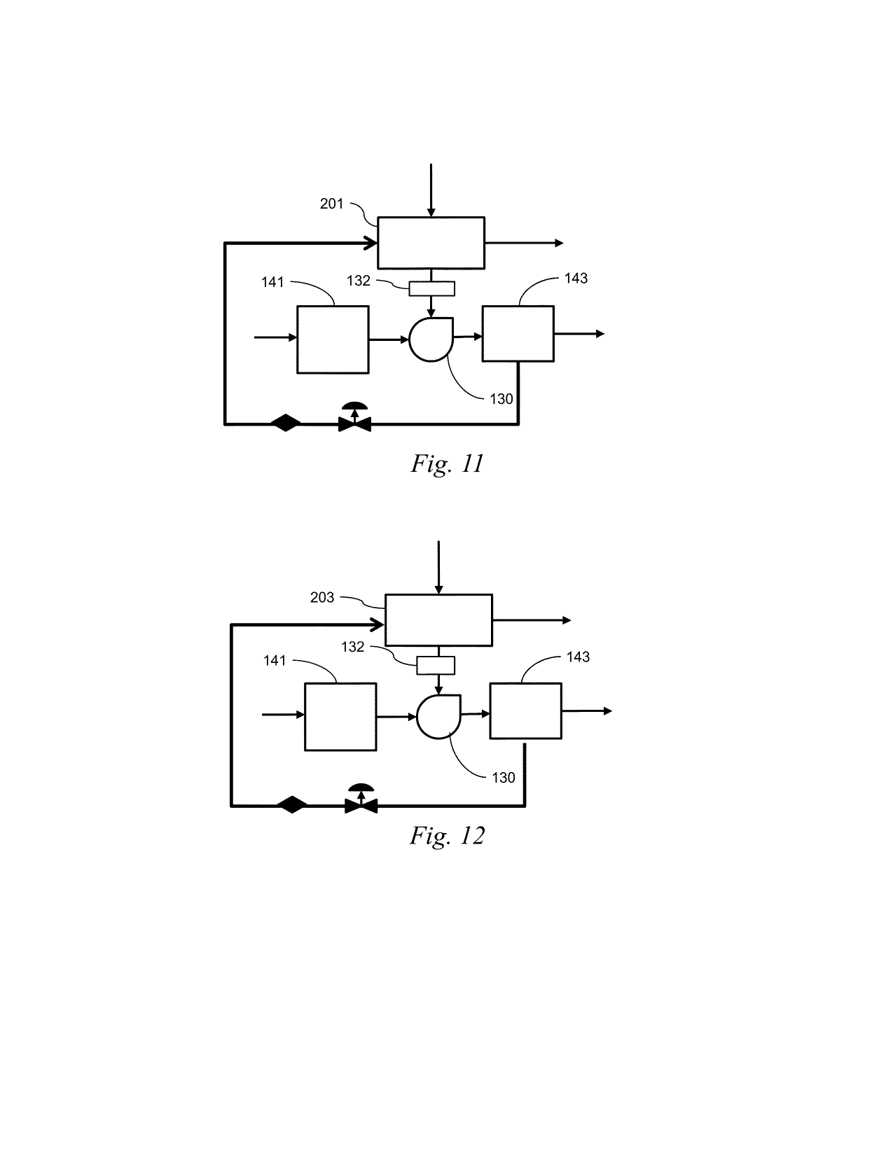

In another embodiment, illustrated in FIG. 12 an aeroderivative gas turbine 203 may be used as the prime mover 131. An aeroderivative gas turbine 203 is a gas turbine derived from an aviation turbine. The decision to use aeroderivative gas turbine 203 is mainly based on economical and operational advantages. They are relatively light weight and offer high performance and efficiency. Aeroderivative gas turbine 203 permits efficient control of torque together with potential for integrated control. Common economic/operational advantages and benefits of the aeroderivative gas turbine 203 compared to conventional heavy frame gas turbine drivers are a 10 to 15 percent improvement in efficiency. An aeroderivative gas turbine 203 provides smooth, controlled start. The aeroderivative gas turbine 203 has higher availability and operational reliability and its wide load range permits economically optimized power control. An aeroderivative gas turbine 203 also provides an advantage over conventional heavy frame gas turbine drivers due to its ability to be shut down, ramp up rapidly and handle load changes more efficiently. An aeroderivative gas turbine 203 provides high cycle efficiency and very high peak output at a fixed supercharger boost. The advantages of the aeroderivative gas turbine 203 for this application must be balanced against some disadvantages, including high capital costs and very high maintenance costs.

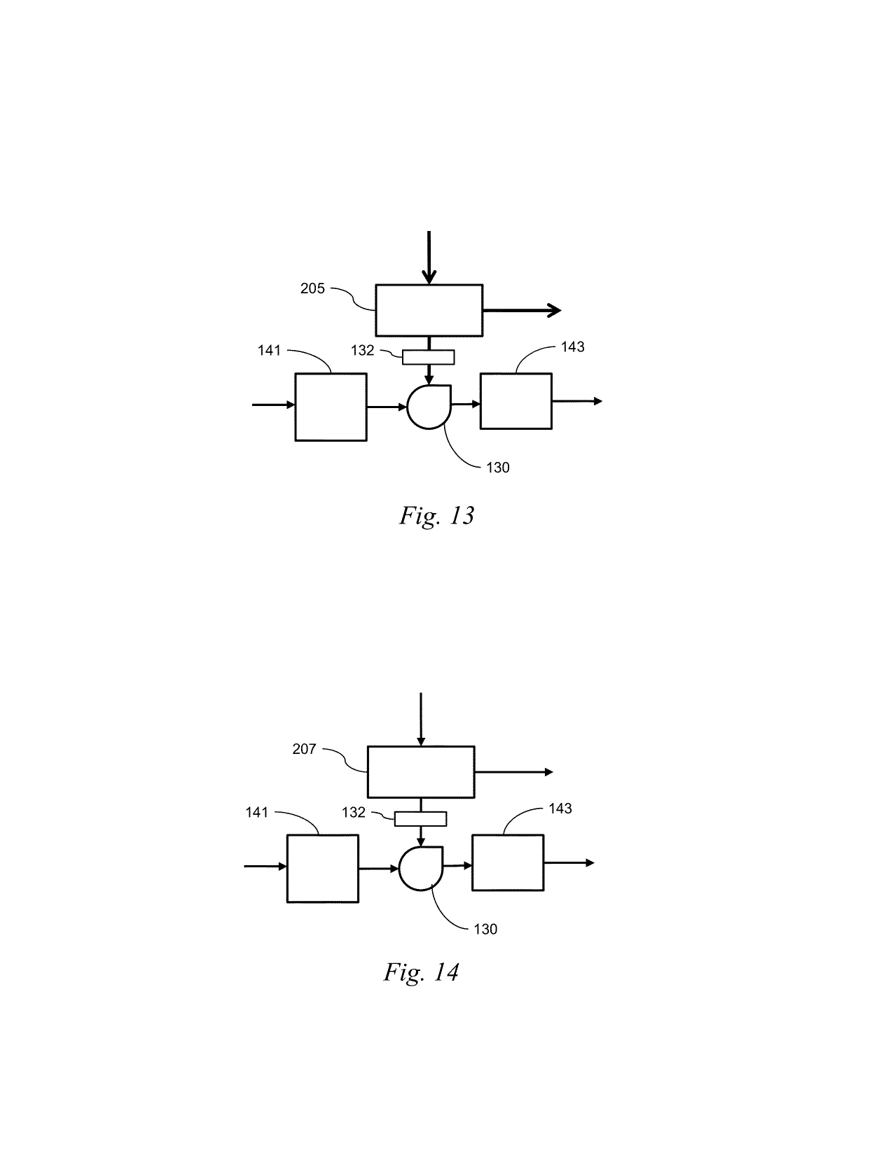

In another embodiment, illustrated in FIG. 13, a steam turbine 205 may be used as the prime mover 131. A steam turbine 205 is a device that extracts thermal energy from pressurized steam and uses it to do mechanical work on a rotating output shaft. The use of a steam turbine 205 provides the advantage of being able to use wide range of fuels to drive the steam turbine 205. In comparison to the other prime movers, the steam turbine 205 has a medium capital cost, maintenance cost, cycle efficiency, and peak output at fixed supercharger boost. Steam turbine 205 also has a high subsystem complexity. However, steam turbine 205 has the disadvantage of requiring boiler and other equipment and a higher price-to-performance ratio. A steam turbine 205 has a slow load change behavior, which means once running the steam turbine 205 cannot be stopped quickly. A specific amount of time is needed to slow down its revolutions. A steam turbine 205 also has poor part load performance.

In another embodiment, illustrated in FIG. 14 an induction motor 207 may be used as the prime mover 131. An induction motor 207 is a type of AC motor where power is supplied to the rotor by means of electromagnetic induction, rather than a commutator or slip rings as in other types of motor. Induction motor 207 has the advantage of being rugged, easy to operate, and having low capital and maintenance costs. Induction motor 207 also has the advantage of providing a subsystem of low complexity. Another advantage of an induction motor 207 is the ability to regulate the torque output and modulate the energy output of the induction motor 175. Induction motor 207 has the disadvantage of having a low cycle efficiency and low peak output at fixed supercharger boost. Additionally, speed of the induction motor 207 decreases as the load increases.

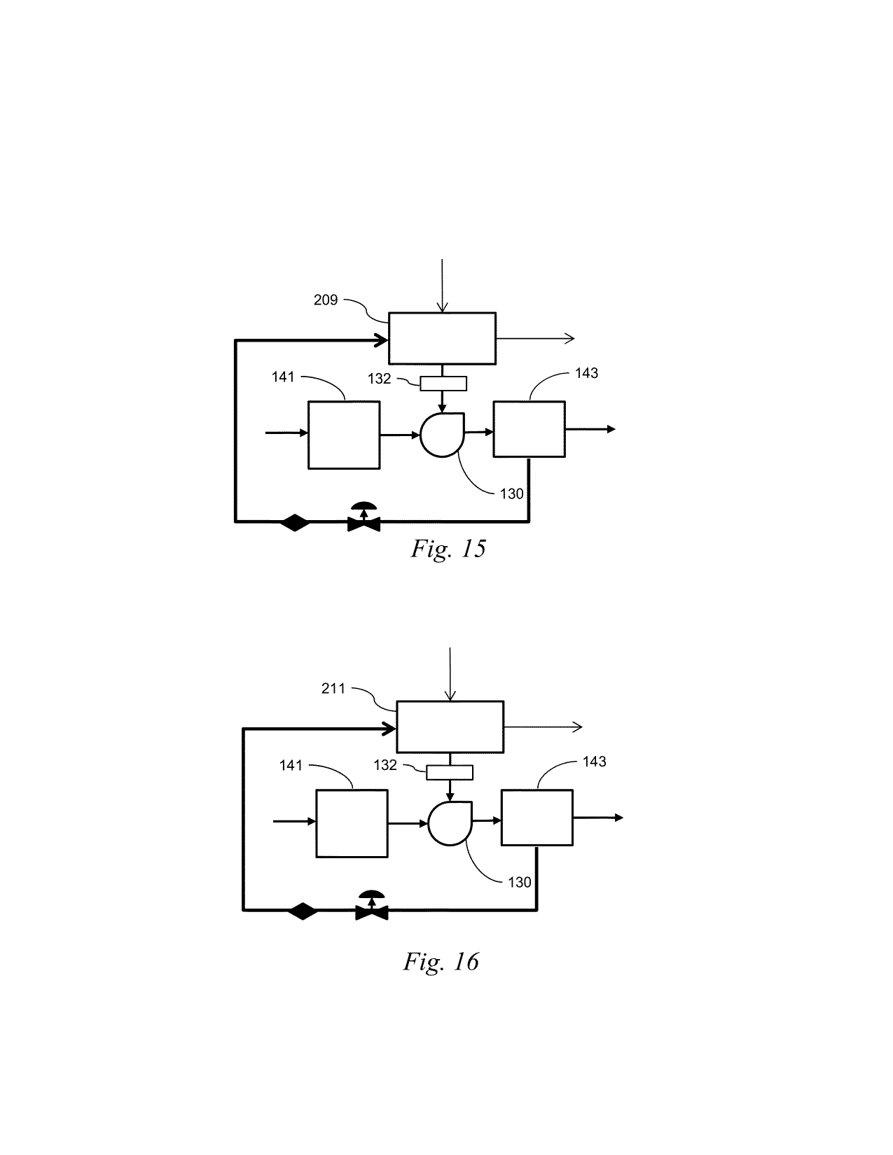

In another embodiment, illustrated in FIG. 15 a reciprocating engine 209 may be used as the prime mover 131. A reciprocating engine 209, also often known as a piston engine, is a heat engine such as a diesel engine that uses one or more reciprocating pistons to convert pressure into a rotating motion. Use of a reciprocating engine 209 to drive the forced draft fan 130 has the advantage of providing high efficiencies at part load operation and high cycle efficiencies. Peak output at fixed supercharger boost is very high with a reciprocating engine 209. Additionally a reciprocating engine 209 has short start-up times to full loads. A reciprocating engine 209 has average capital costs and maintenance cost. The complexity of the subsystem is average when compared to other prime movers.

In another embodiment, illustrated in FIG. 16 a variable frequency drive (VFD 211) may be used as the prime mover 131. A VFD 211 is a drive that controls the rotational speed of an electric motor by controlling the frequency of the electrical power supplied to the motor. A VFD 211 provides a number of advantages, including low subsystem complexity and low maintenance costs as well as energy savings from operating at lower than nominal speeds. A VFD 211 has average capital costs when compared with other prime movers and provides average cycle efficiency. Another advantage is that the VFD 170 may be gradually ramped up to speed lessening the stress on the equipment. A disadvantage is lower than average peak output at a fixed supercharger boost.

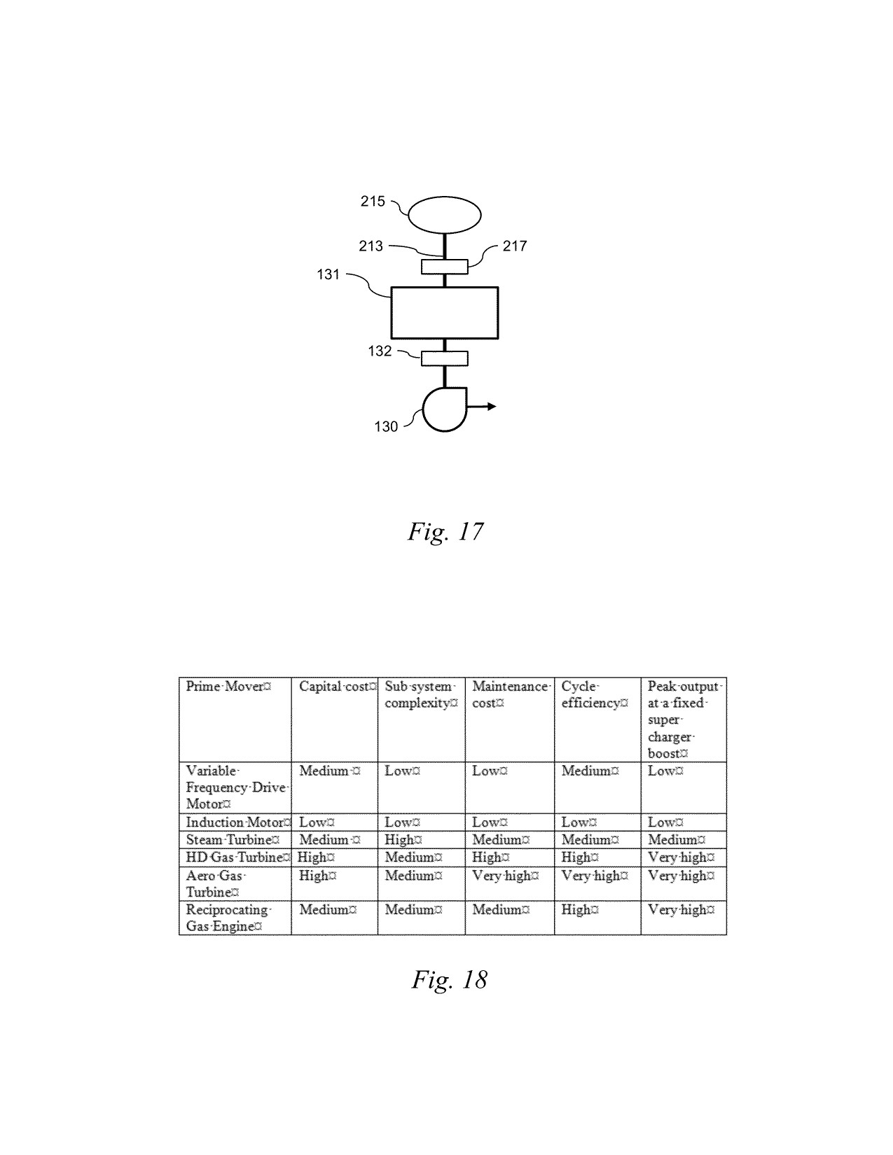

Illustrated in FIG. 17 is yet another embodiment where the drive shaft 213 of a prime mover 131 is coupled to the forced draft fan 130 though a hydraulic coupler 132. The drive shaft 213 of the prime mover 131 is also coupled to an electric generator 215 through a second hydraulic coupler 217. In this embodiment the prime mover 131 can drive the forced draft fan 130, the electric generator 215 or both simultaneously, thereby expanding the combined plant operational flexibility.

FIG. 18 is a table illustrating the advantages and disadvantages of the different prime movers 131.

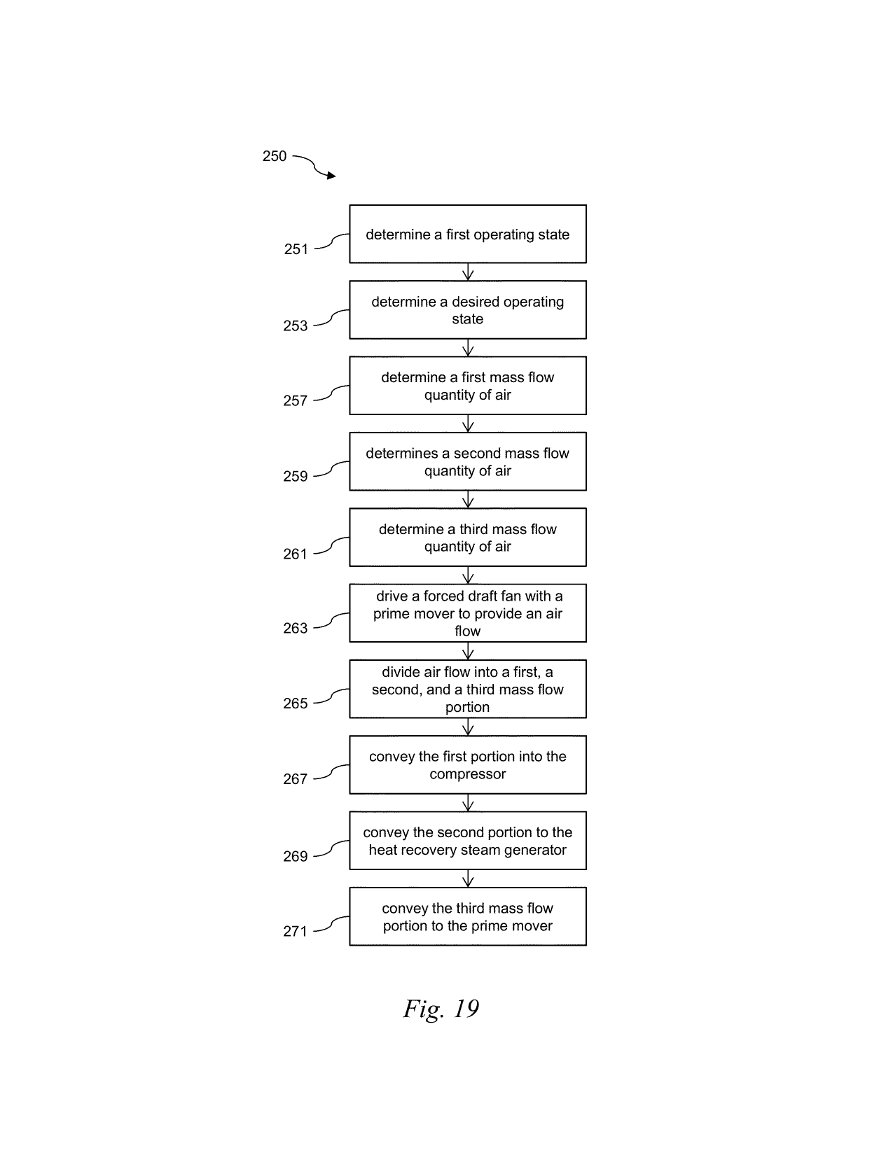

FIG. 19 illustrates a method 250 of operating an SCCAB system 250.

In step 251, the method 250 may determine a first operating state.

In step 253, method 250 may determine a desired operating state.

In step 257 the method 250 may determine a first mass flow quantity of air to be provided to the compressor. The first mass flow quantity of air may be determined based on, among other parameters, the operating conditions, the desired output, and the operating envelope for the gas turbine subsystem 113. For example, the level of supercharging may be determined by a desire to increase the power output at a faster rate or in the case of an SCCAB system 111 with an HRSG 123, by the amount of air required to purge the HRSG 123. Other factors such as compressor fan limitations, fan operability levels (surge line), whether the gas turbine system is operating at its start cycle may determine the first flow rate to be provided to the compressor 15.

In step 259, the method 250 may determine a second mass flow quantity of air to be provided for other uses. The second mass flow rate quantity of air may also be a function of uses for the second mass flow quantity of air. For example if the gas turbine subsystem 113 is part of an SCCAB system 111 having an HRSG 123 with duct combustion then the second portion may be determined on the basis of the oxygen level desired for the duct combustion, thereby determining the first flow rate. Other uses for the second flow rate may include controlling exhaust gas temperatures, controlling the oxygen content of the exhaust, compartment ventilation, plant HVAC and other cooling /heating air services.

In step 261 the method 250 may determine a third mass flow quantity of air to be provided to the prime mover 131.

In step 263, the method 250 may drive the forced draft fan 130 with a prime mover 131 coupled to the hydraulic coupler 132.

In step 265 the method 250 may divide the airflow into a first mass flow portion, a second mass flow portion and a third mass flow portion.

In step 267, the method 250 may convey the first mass flow portion into the compressor.

In step 269, the method 250 may convey the second mass flow portion to the heat recovery steam generator 123.

In step 271, method 250 may convey the third mass flow portion to the prime mover.

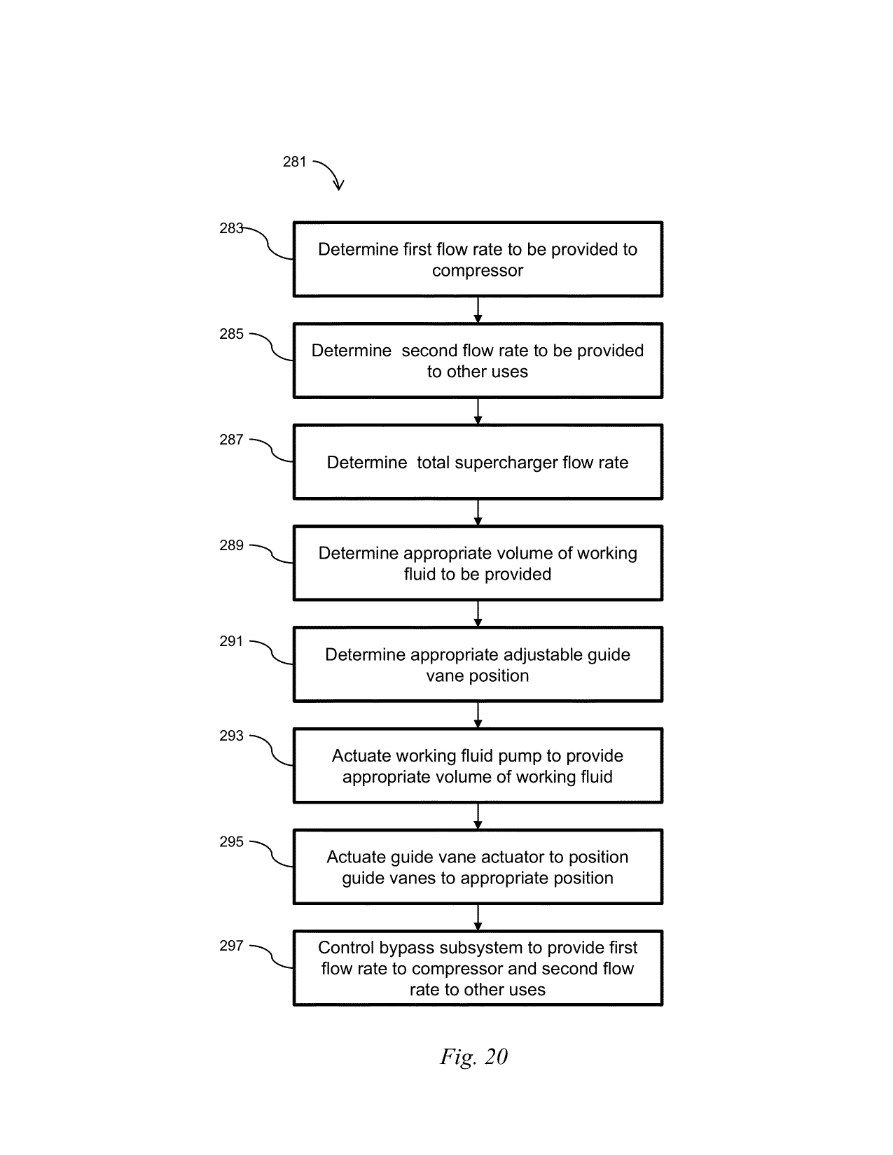

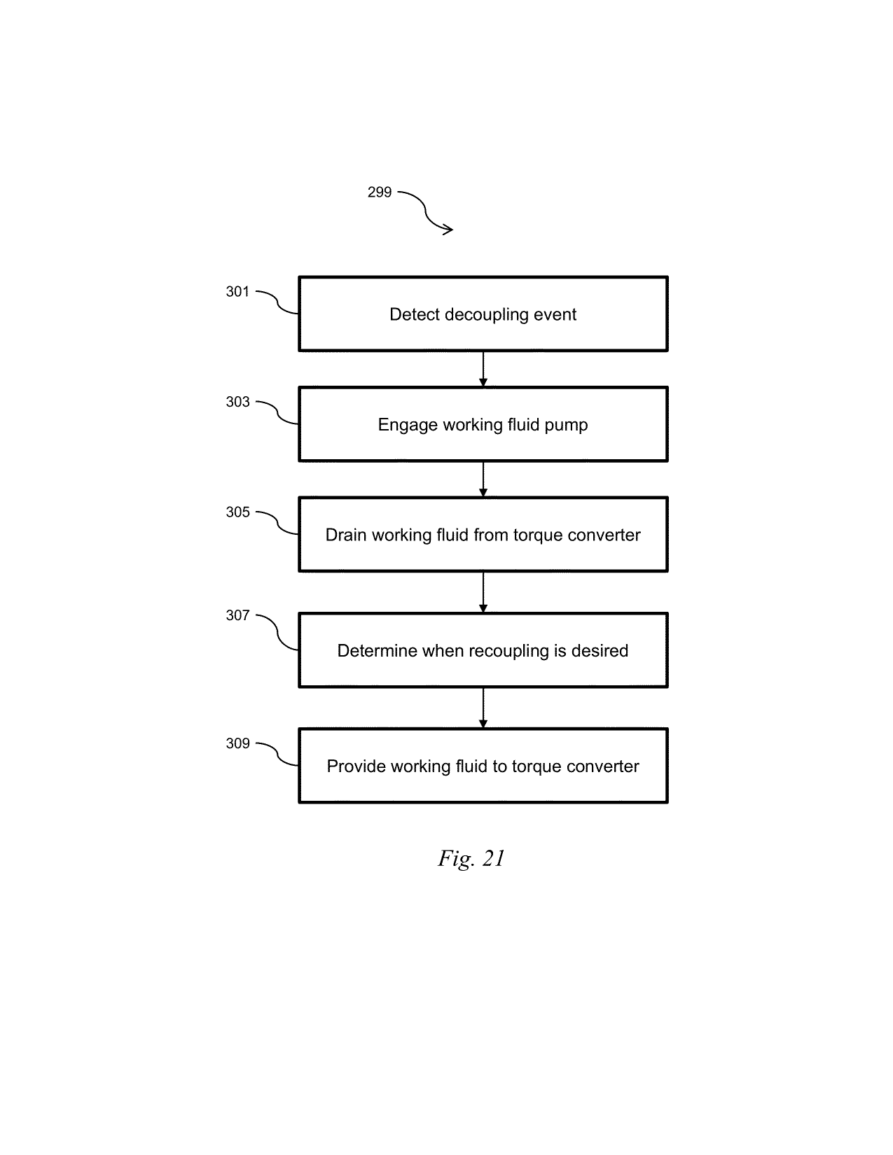

FIG. 20 illustrates a method 281 for operating a supercharged system 111.

In step 283, the method 281 may determine a first flow rate to be provided to the compressor. The first flow rate may be determined based on, among other parameters, the operating conditions, the desired output, and the operating envelope for the gas turbine system 113. For example, the level of supercharging may be determined by a desire to increase the power output at a faster rate or in the case of a supercharged system 111 with an HRSG system 123, by the amount of air required to purge the HRSG system 123. Other factors may determine the first flow rate to be provided to the compressor 115, these factors include as compressor fan limitations, fan operability levels (surge line), whether the gas turbine system is operating at its start cycle may determine the first flow rate to be provided to the compressor 115.

In step 285, the method 281 may determine a second flow rate to be provided for other uses. The first flow rate may also be a function of uses for the second flow rate. For example if the gas turbine system 113 is part of a supercharged system 111 having an HRSG system 123 with duct combustion then the second portion may be determined on the basis of the oxygen level desired for the duct combustion, thereby determining the first flow rate. Other uses for the second flow rate may include controlling exhaust gas temperatures, controlling the oxygen content of the exhaust, compartment ventilation, plant HVAC and other cooling /heating air services.

In step 287, the method 281 may determine the total flow rate to be provided by the supercharger and bypass system 17.

In step 289, the method 281 may then determine the appropriate volume of working fluid to be provided to the hydraulic coupler 132.

In step 291, the method 281 may determine the appropriate position of the adjustable guide vanes 167.

In step 293, the method 281 may actuate the working fluid pump 70 to provide the appropriate volume of working fluid.

In step 295, the method 281 may engage the guide vane actuator 169 to position the adjustable guide vanes 167 to the appropriate position.

In step 297, the method 281 may control the bypass subsystem 133 to provide the first flow rate to the compressor 115 and the second flow rate to other uses.

Illustrated in FIG. 21 is a method 299 for decoupling and recoupling the forced draft fan 130 from the gas turbine system 113.

In step 301, the method 299 may detect a decoupling event. A decoupling event may be a failure of the forced draft fan 130 or other components of the supercharger and bypass system 17.

In step 303, the method 299 may engage the working fluid pump to drain the working fluid from the hydraulic couple 132.

In step 305, the method 299 may drain the working fluid from the hydraulic coupler 132.

In step 307, the method 299 may determine when recoupling is desired.

In step 309, the method 99 may provide working fluid to the torque converter to recouple the force draft fan 130 to the prime mover 131.

The foregoing detailed description has set forth various embodiments of the systems and/or methods via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware. It will further be understood that method steps may be presented in a particular order in flowcharts, and/or examples herein, but are not necessarily limited to being performed in the presented order. For example, steps may be performed simultaneously, or in a different order than presented herein, and such variations will be apparent to one of skill in the art in light of this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A supercharging system for a gas turbine system having a compressor, a combustor, a turbine and a shaft, the supercharging system comprising:
a prime mover a fan assembly that provides an air stream at an air stream flow rate;
a hydraulic coupler coupled to the prime mover and the fan assembly;
a subsystem for conveying a first portion of the air stream to the compressor; and
a bypass subsystem for optionally conveying a second portion of the air stream to other uses.

2. The supercharging system of claim 1 further comprising a control system that controls the bypass subsystem.

3. The supercharging system of claim 1 further comprising a control subsystem that controls the hydraulic coupler thereby controlling the air stream flow rate.

4. The supercharging system of claim 1 wherein the prime mover is a prime mover selected from among the group consisting of a gas turbine, an aeroderivative gas turbine, a steam turbine, an induction motor, a variable frequency drive, and a reciprocating engine.

5. The supercharging system of claim 1 further comprising:
a second hydraulic coupler coupled to the prime mover; and
an electric generator coupled to the second hydraulic coupler.

6. The supercharging system of claim 1 wherein the bypass subsystem comprises external ducting.

7. The supercharging system of claim 6 wherein the bypass subsystem comprises a flow rate sensor and a valve disposed on the external ducting.

8. The supercharging system of claim 7 further comprising a control system, and wherein the control system receives signals from the flow rate sensor and controls the valve.

9. The supercharging system of claim 1 further comprising a cooling system disposed downstream from the fan assembly.

10. A gas turbine system comprising:
a compressor;
a combustor;
a turbine;
a prime mover;
a hydraulic coupler coupled to the prime mover;
a fan coupled to the hydraulic coupler generating an air stream; and
a bypass subsystem that allocates the air stream between the compressor and other uses.

11. The gas turbine system of claim 10 wherein the hydraulic coupler comprises a working fluid pump and adjustable guide vanes.

12. The gas turbine system of claim 10 further comprising a heat recovery steam generator coupled to the turbine and a variable geometry diverter disposed between the fan and the heat recovery steam generator.

13. The gas turbine system of claim 10 wherein the prime mover is one selected from among the group consisting of a gas turbine, an aeroderivative gas turbine, a steam turbine, an induction motor, a reciprocating engine and a variable frequency drive.

14. The gas turbine system of claim 10 further comprising a control system that controls the bypass subsystem.

15. The gas turbine system of claim 12 wherein the variable geometry diverter comprises a conduit and a damper.

16. The gas turbine system of claim 12 wherein the fan comprises a variable pitch blade.

17. The gas turbine system of claim 11 further comprising a control subsystem that controls the working fluid pump and the adjustable guide vanes.

18. A method of operating a gas turbine comprising:
driving a fan assembly with a prime mover attached to a hydraulic coupler;
determining a first flow rate to be provided to a compressor in the gas turbine;
determining a second flow rate to be provided to other uses; and
providing the first flow rate to the compressor, and the second flow rate to the other uses.

19. The method of claim 18 wherein driving a fan assembly with a prime mover comprises driving a fan assembly with a prime mover selected from among the group consisting of a gas turbine, an aeroderivative gas turbine, a steam turbine, an induction motor, a reciprocating engine and a variable frequency drive.

20. The method of operating a gas turbine of claim 18 further comprising:
driving an electric generator with the prime mover attached to a second hydraulic coupler
